(19) United States
(12) Patent Application Publication
(10) Pub. No.: US 2007/0115905 A1
(43) Pub. Date: May 24, 2007

(54) Mechanism for multicast and/or broadcast acknowledgements

(75) Inventors: Jari Jokela, Ylojarvi (FI); Jarkko Kneckt, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/592,745

(22) Filed: Nov. 3, 2006

Related U.S. Application Data
(60) Provisional application No. 60/733,998, filed on Nov. 4, 2005.

(51) Int. Cl. H04Q 7/24; H04J 3/00

(52) U.S. Cl. 370/338; 370/345

(57) ABSTRACT

The present invention provides a new and unique method and apparatus for communicating information between two nodes, points or terminals in a wireless local area network (WLAN), wherein multicast and broadcast data is transmitted in a power save multi poll (PSMP) scheme and the transmitted data is acknowledged between the two nodes, points or terminals in the wireless LAN network. The two nodes, points or terminals may include an access point (AP) or other suitable network node or terminal and a station (STA) or other suitable network node or terminal in the WLAN.

### CROSS-REFERENCE TO RELATED APPLICATIONS

This application claims benefit to provisional patent application Ser. No. 60/733,998, filed on 4 Nov. 2005, which is hereby incorporated by reference in its entirety.

### BACKGROUND OF THE INVENTION

1. Field of Invention

The present invention is related to 802.11 WLAN multicast frames handling, and specifies Mac level enhancements for efficient and robust multicast and/or broadcast delivery enhancements.

2. Description of Related Art

In known networks, the use of WLAN MAC level multicast and/or broadcast transmissions has not been enhanced in WLAN MAC QoS amendments (802.11e). In particular, the MAC—multicast and/or broadcast transmissions do not have the possibility to use acknowledgements. Instead, the known prior art solution sends buffered multicast and/or broadcast frames after DTIM Beacon and multicast and/or broadcast transmissions do not use acknowledgements.

### SUMMARY OF THE INVENTION

The present invention provides a mechanism that enables normal acknowledgement and block acknowledgement use for multicast and/or broadcast transmissions.

In its broadest sense, the present invention provides a new and unique method and apparatus for communicating information between two nodes, points or terminals in a wireless local area network (WLAN), wherein multicast and broadcast data is transmitted in a power save multi poll (PSMP) scheme and the transmitted data is acknowledged between the two nodes, points or terminals in the wireless LAN network.

The two nodes, points or terminals may include an access point (AP) or other suitable network node or terminal and a station (STA) or other suitable network node or terminal in the WLAN.

In effect, the present invention provides PSMP (Power Save Multi Poll) frames use to specify the non-AP STA that transmits an acknowledgement for the multicast and/or broadcast transmissions. A transmitted PSMP shall define the uplink TXOPs. There is always an SIFS period between downlink (DL) and uplink (UL) transmissions. Currently, the known PSMP scheme uses an Association ID to identify unicast recipients. The present invention provides two new options to transmit multicast and/or broadcast information in PSMP frame:

1. All transmission types (unicast, broadcast, multicast) can be performed after PSMP frame. PSMP frame shall specify zero or more non-AP STA to acknowledge the multicast, broadcast or unicast transmission, or

2. The PSMP defines only multicast and broadcast transmission in DL and zero or more transmission times for UL, when multicasts and/or broadcast can be acknowledged.

The present invention also includes a wireless local area network (WLAN) having two nodes or points that communicate information between the same, wherein the two nodes or points have modules configured for transmitting multicast and broadcast data in a power save multi poll (PSMP) scheme and acknowledging the transmitted data between the two nodes, points or terminals in the wireless LAN network, as well as the first node, point or terminal for communicating information to the second node, point or terminal in a wireless local area network (WLAN), consistent with that described herein.

The present invention also includes a computer program product with a program code, which program code is stored on a machine readable carrier, for carrying out the steps of a method transmitting multicast and/or broadcast data in a power save multi poll (PSMP) scheme and acknowledging the transmitted data between the two nodes, points or terminals in the wireless LAN network, when the computer program is run in a module of either a first node, point or terminal, such as an Access Point (AP), a second node, point or terminal, such as a station (STA), or some combination thereof. The method according to the present invention also includes implementing the step of the method via a computer program running in a processor, controller or other suitable module in one or more network nodes, points, terminals or elements in the wireless LAN network. dr

### BRIEF DESCRIPTION OF THE DRAWING

The drawing includes the following Figures, which are not necessarily drawn to scale:

FIG. 1 shows an IEEE 802.11 WLAN system according to some embodiments of the present invention.

FIG. 1b shows a flowchart having the basic steps of the method according to some embodiments of the present invention.

FIG. 2 shows an access point (AP) according to some embodiments of the present invention.

FIG. 3 shows a station (STA) according to some embodiments of the present invention.

FIG. 4 shows an illustration of the multicast transmission flow.

FIGS. 5a and 5b show a Universal Mobile Telecommunications System (UMTS) packet network architecture according to some embodiments of the present invention.

The description below also includes Figures showing various formats for illustrating the present invention.

### BEST MODE OF THE INVENTION

FIG. 1 shows, by way of example, an IEEE 802.11 WLAN system, generally indicated as 2, which provides for communications between communications equipment such as mobile and secondary devices including personal digital assistants (PDAs) 3, laptops 4 and printers 5, etc. The WLAN system may be connected to a wire LAN system that allows wireless devices to access information and files on a file server or other suitable device or connecting to the Internet. The devices can communicate directly with each other in the absence of a base station in a so-called “ad-hoc” network, or they can communicate through a base station, called an access point (AP) in IEEE 802.11 terminology, labeled 6, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

The present invention provides a new and unique method and apparatus for communicating information between two nodes, points or terminals in a wireless local area network (WLAN), wherein multicast and/or broadcast data is transmitted in a power save multi poll (PSMP) scheme and the transmitted data is acknowledged between the two or more nodes, points or terminals in the wireless LAN network. FIG. 1b shows a flowchart having the basic steps 7 and 8 of the method according to some embodiments of the present invention.

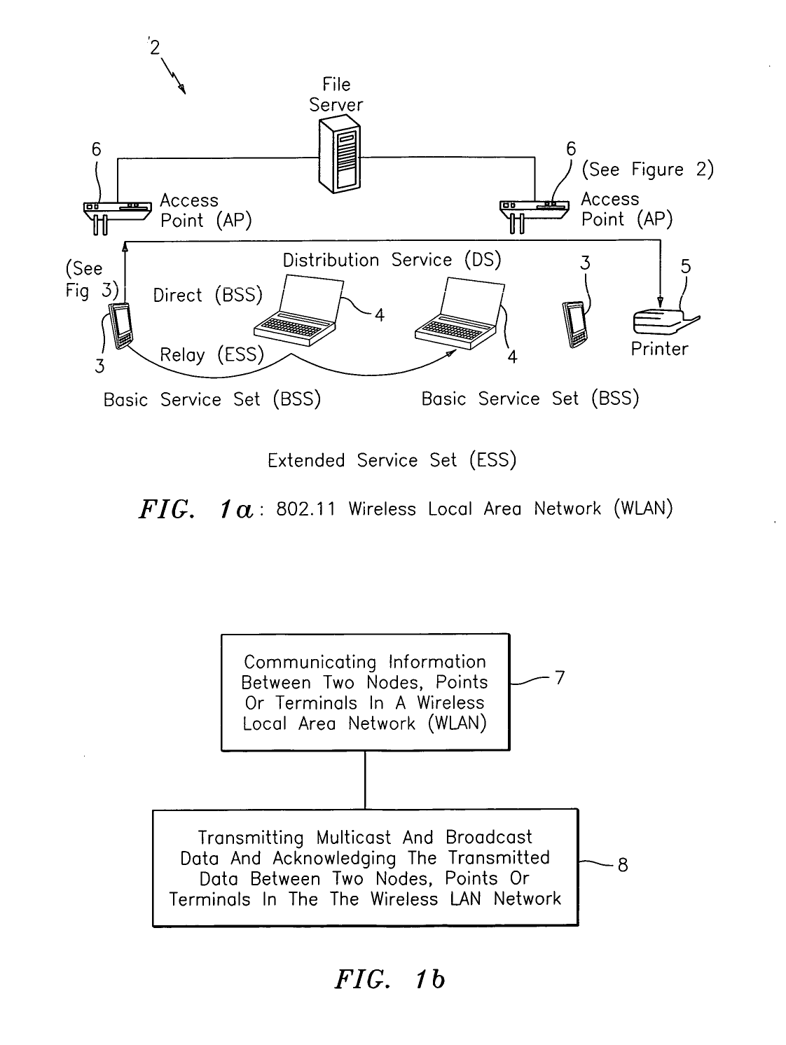

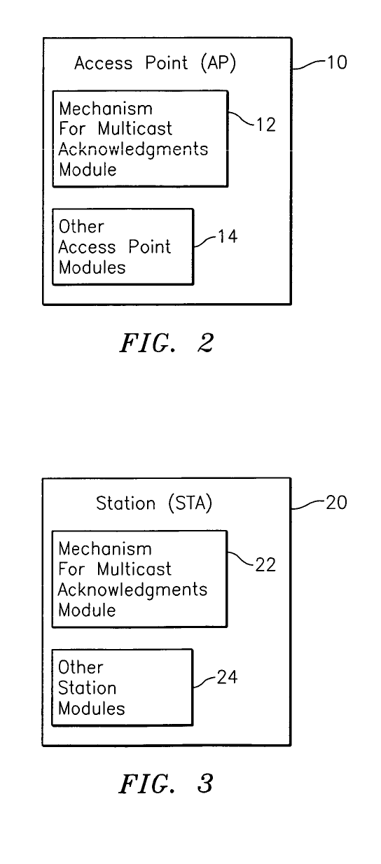

The two nodes, points or terminals in the WLAN may include an access point (AP) or other suitable network node or terminal 10 shown in FIG. 2 and a station (STA) or other suitable network node or terminal 20 shown in FIG. 3, for operating in a wireless LAN network consistent with that shown in FIG. 1a. The AP 10 and the STA 20 have corresponding modules 12 and 22 configured for transmitting multicast and/or broadcast data in a power save multi poll (PSMP) scheme and acknowledging the transmitted data between the two nodes, points or terminals in the wireless LAN network.

### The Basic Implementation

The basic implementation and cooperation of the AP 10 and STA 20 according to the present invention may include the following:

802.11n, high throughput enhancements, define Power Save Multi Poll (PSMP) aggregation mechanism for data transmission. PSMP transmission starts with DL (data from node1) transmission time. After DL transmission time the transmitter of the DL frame may specify time period for UL(data to nodel) transmissions. The present invention provides that DL transmission is used for the multicast and/or broadcast frames and UL transmission time(s) that are specified together with DL multicast and/or broadcast shall transmit acknowledgement for multicast and/or broadcast frame(s). The UL transmission times may contain also other frames, if there is enough transmission time available. The beginning times of the DL and UL transmissions shall be specified so that the time between UL and DL transmissions shall be at least a SIFS period.

The current PSMP mechanism uses Association ID (AID) to identify the receivers for the unicast in PSMP frame. The multicast and/or broadcast transmissions do not have any AID identifier for themselves. The multicast and/or broadcast transmissions shall use the multicast MAC address as an identifier for the coming transmission. The present invention provides two mechanisms for multicast and/or broadcast information passing in PSMP frame.

In option 1, all transmission types, unicasts, multicasts and broadcasts are possible to perform after the PSMP element. One PSMP element may specify the DL multicast and/or broadcast transmission and zero or more non-AP STA that acknowledges the multicast and/or broadcast transmission. The PSMP element may specify several non-AP STA that receive the same DL multicast and/or broadcast transmission. Each of these non-AP STA shall transmit a UL acknowledgement for DL frames if they had specified UL transmission time and DL frames require acknowledgement, i.e. their acknowledgement mode is not set to ‘no acknowledgement’. If the PSMP specifies unicast transmissions, the terminal may acknowledge the transmitted DL unicasts and transmit own unicast frames during the specified UL transmission time. The present invention does not change the handling of the unicast transmissions.

In option 2, one PSMP shall specify only multicast and/or broadcast transmissions and unicast transmissions. Then during the specified UL transmissions times, the non-AP STA shall acknowledge the transmitted multicast and/or broadcasted frames.

The option 1 approach has the same length for each STA Info elements, but it may cause unnecessary wakings for the non-AP STA, because the multicast and/or broadcast frames are specified with only 2 octets. For instance, in IPv4 the last 23 bits (RFC 1188)and in IPv6 4 octets (RFC 2464) are used to specify the multicast address.

The option 2 approach specifies all multicast and/or broadcast addresses more completely, so each multicast and/or broadcast transmissions have the unique address. On the other hand, this mechanism needs to specify new STA Info element.

If a non-AP STA receives several multicast and/or broadcast transmissions from different addresses in one PSMP, the AP may specify the same UL transmission time to transmit acknowledgements for all of these transmissions. The AP shall specify all multicast and/or broadcast addresses separately, i.e. set the STA Info for each multicast and/or broadcast transmission and acknowledgement, where it desires to receive acknowledgement from the non-AP STA.

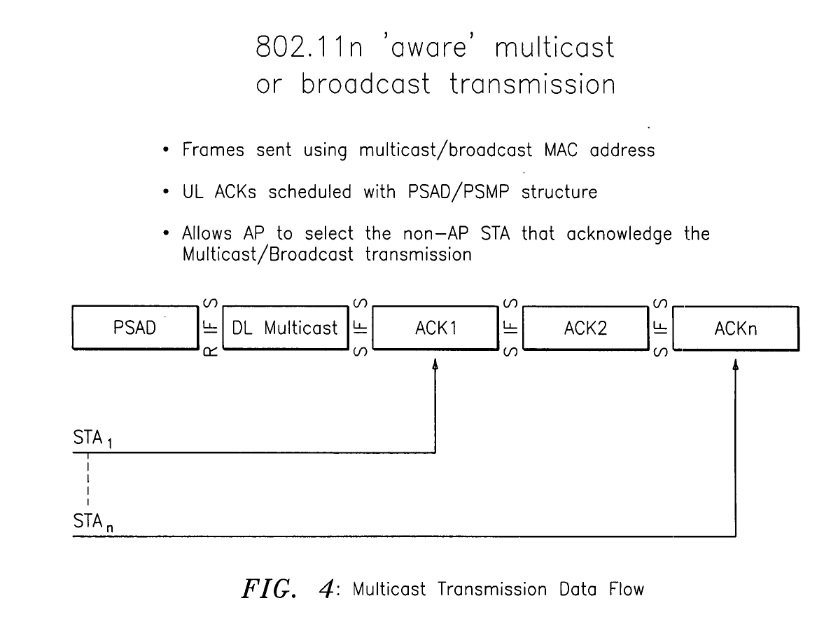

The AP, the transmitter of the multicast and/or broadcast address, may control the amount of acknowledgements for the multicast and the transmitters of the acknowledgement. The acknowledgement mode that is specified in multicast frame specifies the used acknowledgement frame in PSMP UL TXOPs. FIG. 4 shows illustration of the multicast transmission data flow. The AP may freely select the acknowledgement transmitters. The AP shall assume that frame transmission is successful to all non-AP STA were not specified to transmit acknowledgement.

The used acknowledgement mode for multicast and/or broadcast frame transmissions is specified similarly as unicast frames acknowledgement mode. The ACK Policy Field in MAC header's QoS Control specifies the used acknowledgement mode.

If the multicast frame belongs to multicast service, the acknowledgement is used, if both non-AP STA and AP have set the multicast and/or broadcast acknowledgement bit in Radio Resource Management Capability field.

Non-AP STA may fail to acknowledge the transmitted multicast and/or broadcast frame. In the case where retransmissions are needed for the stream, the transmitter may select several acknowledgement and delivery quality control logic for the multicast and/or broadcast:

1) The transmitter may set each receiver to transmit acknowledgement.

2) The transmitter may select the receivers that require the most retransmissions to transmit acknowledgement. The number of transmitters of the acknowledgement may be freely selected.

3) The transmitter may transmit a multicast and/or broadcast frame redundantly, without acknowledgements and control the amount of transmissions through the amount or number of error messages, or triggered multicast measurement messages.

4) The transmitter may change the group of terminals that transmit an acknowledgement. In this operation, the transmitter can control that receivers are in coverage.

5) The transmitter may change to an acknowledgement requesting interval based on received acknowledgements.

6) The transmitter may change the transmission rate based on the response.

7) The transmitter may retransmit the frame as multicast or broadcast transmission until the transmission attempts are exceeding dot11ShortRetryLimit or dot11LongRetryLimit, or the MSDU lifetime have been reached.

8) The transmitter may retransmit the multicasted or broadcasted frame as unicast transmission.

9) The transmitter may change or request change for the media format based on acknowledgements and measurements results.

10) The transmitter may stop requesting ACK from a group of terminals that are not able to receive the transmission. The transmitter may have for instance a predefined minimum transmission rate and if the receivers are not able to receive transmissions correctly, the transmitter may stop requesting ACKs from the group of terminals.

11) The transmitter may stop transmitting the multicast transmission. This may happen for instance, if the delivery quality is inappropriate.

These aforementioned scenarios are provided by way of example only, and the scope of the invention is not intended to be limited to only the same.

The multicast and broadcast retransmissions can be received by all receivers of the multicast or broadcast transmission. Thus, it may be probable that acknowledgements from the receivers that do not receive the transmission correctly may create enough retransmissions to create robustness for all receivers needs.

If multicast and/or broadcast transmissions have been received correctly, embodiments are envisioned in which the transmitter may use a higher transmission rate, not only the lowest rate. The reduction in transmission time consumption may be remarkable. The AP shall consider that multicast and/or broadcast frame(s) delivery to non-AP STAs that were not specified in PSMP frame to transmit acknowledgements was successful.

The multicast and/or broadcast acknowledgement enables rate adaptation logic use, suitable transmission rate use for the link conditions. The acknowledgements can be used as feedback to describe are the data frames received correctly. The use of higher transmission rate may improve the data transmission efficiency. The transmission rate may be set according to terminal that has worse link conditions.

The logic for the mechanism for multicast and/or broadcast acknowledgement is set forth in one or more sections of IEEE 802.11, involves changes to the presently known PSMP frame, and are described herein, as follows:

### 802.11n Multicast ACK Mode

With 802.11n it is possible to create frame sequences that supports reliable multicast transmissions. With this approach, the AP will schedule the UL acknowledgements and sends the schedule in the PSMP frame before the actual DL multicast frame transmission. The PSMP frame defines starting time of DL transmission time and zero or more starting times for the UL transmission time(s). If the address of transmitted data in DL TXOP corresponds to multicast address, the specified terminals in UL TXOP shall transmit acknowledgement or block acknowledgement for the transmitted multicast frame(s). The STAInfo field in PSMP frame also contains a bit that indicates is the transmission type multicast or unicast.

If the multicast frame belongs to multicast service, the acknowledgement may be used, if both non-AP STA and AP have set the multicast acknowledgement bit in Radio Resource Management Capability field. The acknowledgements for broadcast may be used, if both non-AP STA and AP have set the multicast acknowledgement bit in Radio Resource Management Capability field.

If non-AP STA fails to acknowledge the transmitted multicast frame the AP shall retransmit the frame as multicast transmission until the transmission attempts are exceeding dot11ShortRetryLimit or dot11LongRetryLimit, or the MSDU lifetime have been reached. If non-AP STA fails to acknowledge the transmitted broadcast frame the AP shall retransmit the frame as broadcast transmission until the transmission attempts are exceeding dot11ShortRetryLimit or dot11LongRetryLimit, or the MSDU lifetime have been reached. In other embodiment of the invention the AP may use unicast transmission mode for the retransmissions. The AP shall require acknowledgement in retransmission only from the non-AP STA(s) whose acknowledgement was not received correctly by the AP. The AP shall consider that multicast frame(s) delivery to non-AP STAs that were not specified in PSMP frame to transmit acknowledgements was successful.

The AP need not to require acknowledgements from all receivers in multicast transmission.

The following is a detailed description of the PSMP aggregation as specified in the current IEEE proposal, the PSMP aggregation option 1 for multicast aggregation, and the PSMP aggregation option 1 For multicast aggregation:

### PSMP Aggregation, Option 1 for Multicast Aggregation

The Duration/ID field of the PSMP frame indicates at least the total time duration of all of the DLT and ULT TXOPs which are described by the current PSMP frame. STA's shall update their NAV accordingly on reception of the PSMP frame. The PSMP frame format shall be supported by APs. The PSMP frame format shall be used with multireceiver aggregates whether in the same PPDU or HTP burst. Within all data or management type frames sent within a PSMP exchange, the Duration/ID field is set to the remaining duration of the PSMP exchange.

The frame body of a control frame (Type=0b01) of subtype PSMP (0b0111), Power Saving Aggregation Descriptor, contains the information shown in Table 1.

| Type value | | Subtype Value | Subtype |
|---|---|---|---|
| b3 b2 | Type Description | b7 b6 b5 b4 | Description |
| 01 | Control | 0111 | Power Saving |
| | | | Aggregation |
| | | | Descriptor |
| 01 | Control | 0000-0110 | Reserved |

TABLE 2
PSMP Frame Body

| Order | Information | Notes |
|---|---|---|
| 1 | PSMP Parameter Set | Describes the DLT |
| | | and ULT of the |
| | | current PSMP frame |

The PSMP parameter set is used to describe the DLT and ULT which immediately follows the PSMP frame.

PSMP Parameter Set format

| | | Descriptor | STA |
|---|---|---|---|
| | Reserved | End | Info |
| Bits: | 7 | 9 | 64 * m |

The Descriptor End field indicates the duration of the current PSMP exchange which is described by the PSMP frame. The value of the Descriptor End field is an integer number of 8us. Therefore, this field can describe a PSMP exchange of up to 4 ms in duration. The ‘m’ represents number of STAs included in the PSMP descriptor.

STA Info format

| | | | | DLT | DLT | ULT | |
|---|---|---|---|---|---|---|---|
| | | Multicast/ | STA | Start | Dura- | Start | ULT |
| | Rsrvd | Broadcast | ID | Offset | tion | Offset | Duration |
| Bits: | 5 | 1 | 16 | 11 | 10 | 11 | 10 |

Multicast/Broadcast bit is set to 1, when the STA Info contains multicast or broadcast transmission information. When this bit is set the STA ID field shall contain the last 2 octets of the multicast MAC address. This bit also defines that the same values in STA ID, DLT Start Time and DLT Duration may be given to several non-AP STA in TXOP.

The STA ID field indicates the AID value in infrastructure mode and the last two bytes of the MAC address in multicast or broadcast transmissions, when Multicast/Broadcast bit is set or in Ad-hoc mode.

The DLT Start Offset field indicates the start of the PPDU which has the DL data of the STA. The offset is specified relative to the end of the PSMP frame. It is given as an integer number of 2us. If no DLT.is scheduled for a STA, but a ULT is scheduled for that STA, then the DLT Duration is set to null (0).

The DLT Duration field indicates the end of DL data of a STA relative from the start of the PSDU that has the first MPDU destined to the STA. It is given as a multiple of 4us. If no ULT is scheduled for a STA, but a DLT is scheduled for that STA, then the ULT Duration is set to null (0).

The ULT Start Offset field indicates the start of the ULT. The first ULT is scheduled to begin after a SIFS interval from the end of the last DLT described in the PSMP. If no ULT is scheduled for a STA, but a DLT is scheduled for that STA, then the ULT Start Offset is set to null (0). A STA starts transmitting with out performing the required CCA at the start of its ULT Offset.

The ULT Duration field indicates the maximum length of a ULT for a STA. Even, if a STA has more data queued than the allocated time for its ULT, the STA shall release the medium at the end of the allocated duration. ULT duration is given as an integer number of 4 us. If no ULT is scheduled for a STA, but a DLT is scheduled for that STA, then the ULT duration is set to null (0). A STA cannot use the medium longer than the time allocated in PSMP frame.

If a PSMP is not received correctly by a receiving STA, then a STA can still decode its data by examining each PPDU to discover frames for which it is the intended recipient, but it shall not attempt to send any ULT frames.

An AP shall schedule all the downlinks before all the uplinks. All bursts within the PSMP exchange, except for the burst carrying the PSMP frame itself shall use the short preamble.

### PSMP Aggregation Option 2 For Multicast Aggregation

The Duration/ID field of the PSMP frame indicates at least the total time duration of all of the DLT and ULT TXOPs which are described by the current PSMP frame. STA's shall update their NAV accordingly on reception of the PSMP frame. The PSMP frame format shall be supported by APs. The PSMP frame format shall be used with multireceiver aggregates whether in the same PPDU or HTP burst. Within all data or management type frames sent within a PSMP exchange, the Duration/ID field is set to the remaining duration of the PSMP exchange.

The frame body of a control frame (Type=0b01) of subtype PSMP (0b0111), Power Saving Aggregation Descriptor, contains the information shown in Table 3.

| Type value | | Subtype Value | Subtype |
|---|---|---|---|
| b3 b2 | Type Description | b7 b6 b5 b4 | Description |
| 01 | Control | 0111 | Power Saving |
| | | | Aggregation |
| | | | Descriptor |
| 01 | Control | 0000-0110 | Reserved |

TABLE 4
PSMP Frame Body

| Order | Information | Notes |
|---|---|---|
| 1 | PSMP Parameter Set | Describes the DLT |
| | | and ULT of the |
| | | current PSMP frame |

The PSMP parameter set is used to describe the DLT and ULT which immediately follows the PSMP frame.

PSMP Parameter Set format

| | | Multicats/ | Descriptor | STA |
|---|---|---|---|---|
| | Reserved | Broadcast | End | Info |
| Bits: | 6 | 1 | 9 | 64 * m |
| | | | | or |
| | | | | 92 * n |

The Mutlicast/Broadcast bit is set to 1, when the STA Info contains Multicast/Broadcast STA Info element(s). The Multicast/Broadcast bit is set to 0, when the STA Info field contains Unicast STA Info element(s). All STA Info elements in PSMP element shall have the same format as specified be this bit.

The Descriptor End field indicates the duration of the current PSMP exchange which is described by the PSMP frame. The value of the Descriptor End field is an integer number of 8us. Therefore, this field can describe a PSMP exchange of up to 4 ms in duration. The ‘m’ represents number of STAs included in the PSMP descriptor.

STA Multicast/Broadcast Info format

| | | | DLT | | ULT | |
|---|---|---|---|---|---|---|
| | | MAC | Start | DLT | Start | ULT |
| | Rsrvd | Address | Offset | Duration | Offset | Duration |
| Bits: | 6 | 48 | 11 | 10 | 11 | 10 |

STA Unicast Info format

| | | | DLT | | ULT | |
|---|---|---|---|---|---|---|
| | | STA | Start | DLT | Start | ULT |
| | Rsrvd | ID | Offset | Duration | Offset | Duration |
| Bits: | 6 | 16 | 11 | 10 | 11 | 10 |

The MAC address indicates MAC address of the transmitted Multicast or Broadcast address.

The STA ID field indicates the AID value in infrastructure mode and the last two bytes of the MAC address in Ad-hoc mode.

The DLT Start Offset field indicates the start of the PPDU which has the DL data of the STA. The offset is specified relative to the end of the PSMP frame. It is given as an integer number of 2us. If no DLT is scheduled for a STA, but a ULT is scheduled for that STA, then the DLT Duration is set to null (0).

The DLT Duration field indicates the end of DL data of a STA relative from the start of the PSDU that has the first MPDU destined to the STA. It is given as a multiple of 4us. If no ULT is scheduled for a STA, but a DLT is scheduled for that STA, then the ULT Duration is set to null (0).

The ULT Start Offset field indicates the start of the ULT. The first ULT is scheduled to begin after a SIFS interval from the end of the last DLT described in the PSMP. If no ULT is scheduled for a STA, but a DLT is scheduled for that STA, then the ULT Start Offset is set to null (0). A STA starts transmitting with out performing the required CCA at the start of its ULT Offset.

The ULT Duration field indicates the maximum length of a ULT for a STA. Even, if a STA has more data queued than the allocated time for its ULT, the STA shall release the medium at the end of the allocated duration. ULT duration is given as an integer number of 4 us. If no ULT is scheduled for a STA, but a DLT is scheduled for that STA, then the ULT duration is set to null (0). A STA cannot use the medium longer than the time allocated in PSMP frame.

If a PSMP is not received correctly by a receiving STA, then a STA can still decode its data by examining each PPDU to discover frames for which it is the intended recipient, but it shall not attempt to send any ULT frames.

An AP shall schedule all the downlinks before all the uplinks. All bursts within the PSMP exchange, except for the burst carrying the PSMP frame itself shall use the short preamble.

Implementation of the Functionality of the Modules

The functionality of the AP 10 and STA 20 described above may be implemented in the corresponding modules 12 and 22 shown in FIGS. 2 and 3. By way of example, and consistent with that described herein, the functionality of the modules 12 and 22 may be implemented using hardware, software, firmware, or a combination thereof, although the scope of the invention is not intended to be limited to any particular embodiment thereof. In a typical software implementation, the module 12 and 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 12 and 22 being a stand alone modules, as shown, or in the combination with other circuitry for implementing another module.

The other modules 14 and 24 and the functionality thereof are known in the art, do not form part of the underlying invention per se, and are not described in detail herein. For example, the other modules 24 may include other modules that formal part of a typical mobile telephone or terminal, such as a UMTS subscriber identity module (USIM) and mobile equipment (ME) module, which are known in the art and not described herein.

In operation, the present invention allows for the possibility to use acknowledgements in multicast and broadcast frames delivery, which creates robustness and reliability to data transmission; allows for the possibility to control which non-AP STA transmit the acknowledgements; and also allows for the possibility to use rate adaptation logic

### Universal Mobile Telecommunications System (UMTS) Packet Network Architecture

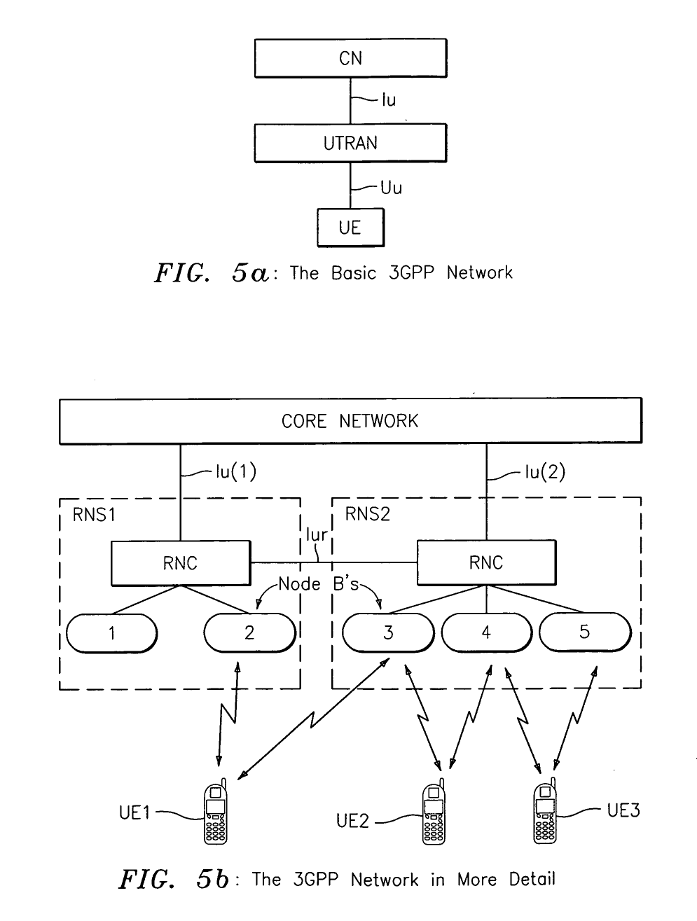

FIGS. 5a and 5b show a Universal Mobile Telecommunications System (UMTS) packet network architecture. In FIG. 5a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 5b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 5a. A given UE may be in radio contact with multiple Node Bs even if one or more of the Node Bs are connected to different RNCs. For instance, a UE1 in FIG. 5b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1a and the (UMTS) packet network architecture in FIGS. 5a and 5b has resulted in STAs taking the form of UEs, such as mobile phones or mobile terminals. The interworking of the WLAN (IEEE 802.11) shown in FIG. 1a with such other technologies (e.g. 3GPP, 3GPP2 or 802.16) such as that shown in FIGS. 5a and 5b is being defined at present in protocol specifications for 3GPP and 3GPP2. The scope of the invention is intended to include implementations of the same in relation to such a UMTS packet network architecture.

List of Abbreviations

| | |
|---|---|
| AC | Access Category |
| A-MSDU | Aggregated MSDU |
| AP | Access Point |
| MAC | Medium access control |
| MSDU | MAC service data unit |
| PSMP | Power Save Multi Poll |
| QAP | QoS access point |
| QoS | Quality of service |
| QSTA | QoS station |
| RTP | Real Time Protocol |
| STA | Station |

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method comprising:
communicating information between two nodes, points or terminals in a wireless local area network (WLAN); and
transmitting multicast and/or broadcast data and acknowledging the transmitted data between the two nodes, points or terminals in the wireless LAN network.

2. A method according to claim 1, wherein the two nodes, points or terminals include an access point (AP) or other suitable network node or terminal and a station (STA) or other suitable network node or terminal in the WLAN.

3. A method according to claim 1, wherein in the Power Save Multi-Poll (PSMP) scheme is used to enable multicast and/or broadcast acknowledging.

4. A method according to claim 1, wherein in the Power Save Multi-Poll (PSMP) scheme for data transmission the DL TXOP is used for the multicast frame(s) and the UL TXOPs are used to give transmission time for multicast and/or broadcast acknowledgements.

5. A method according to claim 1, wherein in the Power Save Multi Poll (PSMP) scheme for data transmission the DL TXOP is used for the multicast and/or broadcast frame and the UL TXOPs are used to give transmission time for multicast acknowledgements and UL unicast transmissions.

6. A method according to claim 1, wherein the multicast and/or broadcast transmissions use the multicast MAC address as an identifier for the coming transmission.

7. A method according to claim 1, wherein one PSMP element specifies the DL multicast and/or broadcast transmission and zero or more non-AP STA(s) that acknowledge the multicast and/or transmission.

8. A method according to claim 5, wherein the PSMP element specifies several non-AP STA that receive the same DL multicast and/or broadcast transmission.

9. A method according to claim 1, wherein one PSMP specifies only multicast and/or broadcast transmissions and unicast transmissions.

10. A method according to claim 7, wherein, during the specified UL transmissions times, a non-AP STA shall acknowledge the transmitted multicast and/or broadcasted frames.

11. A wireless local area network (WLAN) comprising:
two nodes or points that communicate information between the same, the two nodes or points having modules configured for transmitting multicast and/or broadcast data in a power save multi-poll (PSMP) scheme and acknowledging the transmitted data between the two nodes, points or terminals in the wireless LAN network.

12. A wireless local area network (WLAN) according to claim 9, wherein the two nodes, points or terminals include an access point (AP) or other suitable network node or terminal and a station (STA) or other suitable network node or terminal in the WLAN.

13. A wireless local area network (WLAN) according to claim 9, wherein in the Power Save Multi Poll (PSMP) scheme for data transmission the DL TXOP is used for the multicast and/or broadcast frame and the UL TXOPs are used to give transmission time for multicast and/or acknowledgements.

14. A wireless local area network (WLAN) according to claim 9, wherein the multicast transmissions use the multicast MAC address as an identifier for the coming transmission.

15. A wireless local area network (WLAN) according to claim 9, wherein one PSMP element specifies the DL multicast or broadcast transmission and one non-AP STA that acknowledges the multicast and/or transmission.

16. A wireless local area network (WLAN) according to claim 13, wherein the PSMP element specifies several non-AP STA that receive the same DL multicast and/or broadcast transmission.

17. A wireless local area network (WLAN) according to claim 9, wherein one PSMP specifies only multicast and/or broadcast transmissions and unicast transmissions.

18. A wireless local area network (WLAN) according to claim 15, wherein, during the specified UL transmissions times, a non-AP STA shall acknowledge the transmitted multicast and/or broadcasted frames.

19. A first node, point or terminal comprising:
one or more modules for communicating information to a second node, point or terminal in a wireless local area network (WLAN); and
a module configured for transmitting multicast and/or broadcast data in a power save multi poll (PSMP) scheme and acknowledging the transmitted data between the two nodes, points or terminals in the wireless LAN network.

20. A first node, point or terminal according to claim 17, wherein the two nodes, points or terminals include an access point (AP) or other suitable network node or terminal and a station (STA) or other suitable network node or terminal in the WLAN.

21. A first node, point or terminal according to claim 17, wherein in the Power Save Multi Poll (PSMP) scheme for data transmission the DL TXOP is used for the multicast and/or broadcast frame and the UL TXOPs are used to give transmission time for multicast and/or broadcast acknowledgements.

22. A first node, point or terminal according to claim 17, wherein the multicast and/or broadcast transmissions use the multicast MAC address as an identifier for the coming transmission.

23. A first node, point or terminal according to claim 17, wherein one PSMP element specifies the DL multicast and/or broadcast transmission and one non-AP STA that acknowledges the multicast and/or broadcast transmission.

24. A first node, point or terminal according to claim 21, wherein the PSMP element specifies several non-AP STA that receive the same DL multicast and/or broadcast transmission.

25. A first node, point or terminal according to claim 17, wherein one PSMP specifies only multicast and/or broadcast transmissions and unicast transmissions.

26. A first node, point or terminal according to claim 23, wherein, during the specified UL transmissions times, a non-AP STA shall acknowledge the transmitted multicast and/or broadcasted frames.

27. A first node, point or terminal according to claim 19, wherein, in the case where retransmissions are needed for the stream, a transmitter of the first node, point or terminal may select several acknowledgement and delivery quality control logic for the multicast and/or broadcast, including:
1) The transmitter may set each receiver to transmit acknowledgement; or
2) The transmitter may select the receivers that require the most retransmissions to transmit acknowledgement, and the number of transmitters of the acknowledgement may be freely selected; or
3) The transmitter may transmit a multicast and/or broadcast frame redundantly, without acknowledgements and control the amount of transmissions through the amount or number of error messages, or triggered multicast measurement messages; or
4) The transmitter may change the group of terminals that transmit an acknowledgement, so that in this operation the transmitter can control that receivers are in coverage; or
5) The transmitter may change to an acknowledgement requesting interval based on received acknowledgements; or
6) The transmitter may change the transmission rate based on the response; or
7) The transmitter may retransmit the frame as multicast or broadcast transmission until the transmission attempts are exceeding dot11ShortRetryLimit or dot11LongRetryLimit, or the MSDU lifetime have been reached; or
8) The transmitter may retransmit the multicasted or broadcasted frame as unicast transmission; or
9) The transmitter may change or request change for the media format based on acknowledgements and measurements results; or
10) The transmitter may stop requesting ACK from a group of terminals that are not able to receive the transmission. The transmitter may have for instance a predefined minimum transmission rate and if the receivers are not able to receive transmissions correctly, the transmitter may stop requesting ACKs from the group of terminals; or
11) The transmitter may stop transmitting the multicast transmission, where this may happen, for instance, if the delivery quality is inappropriate;
12) Some combination of the aforementioned.

28. A computer program product with a program code, which program code is stored on a machine readable carrier, for carrying out the steps of a method comprising transmitting multicast and/or broadcast data in a power save multi poll (PSMP) scheme and acknowledging the transmitted data between the two nodes, points or terminals in the wireless LAN network, when the computer program is run in a module of either a first node, point or terminal, such as an Access Point (AP), a second node, point or terminal, such as a station (STA), or some combination thereof.

29. A method according to claim 1, wherein the method further comprises implementing the step of the method via a computer program running in a processor, controller or other suitable module in one or more network nodes, points, terminals or elements in the wireless LAN network.

30. Apparatus comprising:
means for communicating information between two nodes, points or terminals in a wireless local area network (WLAN); and
means for transmitting multicast and/or broadcast data and acknowledging the transmitted data between the two nodes, points or terminals in the wireless LAN network.

31. Apparatus according to claim 30, wherein the two nodes, points or terminals include an access point (AP) or other suitable network node or terminal and a station (STA) or other suitable network node or terminal in the WLAN.

32. Apparatus according to claim 30, wherein in the Power Save Multi-Poll (PSMP) scheme is used to enable multicast and/or broadcast acknowledging.

33. Apparatus according to claim 30, wherein in the Power Save Multi-Poll (PSMP) scheme for data transmission the DL TXOP is used for the multicast frame(s) and the UL TXOPs are used to give transmission time for multicast and/or broadcast acknowledgements.
